(19) United States
(12) Patent Application Publication
(10) Pub. No.: US 2022/0164729 A1
(43) Pub. Date: May 26, 2022

(54) AUTOMATED CONTROL COMPLIANCE EVIDENCE MANAGER USING A SECURE DISTRIBUTED LEDGER

(71) Applicant: Capital One Services, LLC, McLean, VA (US)

(72) Inventors: John FIELDS, Henrico, VA (US); Scott D. DYSART, Richmond, VA (US); Jonathan WEIMER, Henrico, VA (US); Maimi NIINA, Washington, DC (US); Stephen DITELJAN, San Francisco, CA (US); Ayrton TRUJILLO, McLean, VA (US); Joseph MEHR, San Francisco, CA (US); Thomas LE, Oakland, CA (US); Kellie WATTS, Henrico, VA (US)

(73) Assignee: Capital One Services, LLC, McLean, VA (US)

(21) Appl. No.: 17/100,094

(22) Filed: Nov. 20, 2020

(51) Int. Cl. G06Q 10/06; H04L 9/06

(52) U.S. Cl. CPC G06Q 10/0635; H04L 9/0637

(57) ABSTRACT

The exemplary embodiments provide an automated control compliance evidence manager that is responsible for gathering evidence of compliance with controls. The control compliance evidence manager may operate on an ongoing basis. In some exemplary embodiments, the evidence is gathered and available for review in real time or near real time. The steps for gathering the compliance evidence may be specified at the time a control is established so that there is consistency in what is gathered and how the evidence is gathered. A user may be required to provide an itemization of what evidence is to be gathered and where. The evidence may be stored in an immutable fashion. In some exemplary embodiments, the evidence may be cryptographically hashed or otherwise encrypted and referenced by a secure distributed ledger, like a blockchain. The distributed ledger may be visible to concerned parties.

### BACKGROUND

Risk management seeks to identify risks for an organization, like a business and then either mitigate or remove the identified risks. One variety of tool used in risk management is a control. A control is an activity that prevents risks, mitigates risks or detects risks. Controls may generally be classified as being either preventive or detective. Preventive controls seek to prevent or mitigate risks and may prevent undesirable events from happening and/or encourage desirable events from happening. Detective controls detect undesirable events.

Some controls may be automated so that the steps associated with such controls are performed automatically by systems like computer systems or machines. These systems may allow a user to define a control and then implement the control on a computer system or other machine in an automated fashion. For example, a control may be automated that requires a user to be prompted for login credentials followed by two-factor authentication before being granted access to servers of a business.

### SUMMARY

In accordance with an exemplary embodiment, a method is performed in a computing environment. Per the method, a specification of a control is received in the computing environment, wherein the specification of the control sets forth activities to be performed and/or conditions to be satisfied as part of the control and also specifies evidence of compliance with the control to be generated. The specification of the control is programmatically analyzed to identify the evidence of compliance to be generated from a source of operational data, and the evidence is programmatically caused to be generated from the source of operational data. The generated evidence is stored in a storage in an immutable manner, and the evidence is referenced on a blockchain or other secure, distributed electronic ledger. The generated evidence from the blockchain or secure distributed ledger is programmatically gathered. The gathered evidence is analyzed to determine whether there has been compliance with the control. Where it is determined that there has been compliance, a notice of compliance is generated, or a report is output on an output device. Where it is determined that there has not been compliance, one of a notice or an alert of non-compliance is generated.

The generating of the evidence and the storing of the evidence may occur in real time, in near-real time, at time intervals or in a delayed fashion. The analyzing may be performed by a programmatic entity. The programmatically gathering the evidence may entail processing system logs to extract the evidence or processing a stream of events. The gathered evidence may be stored in one of a database or a secure storage. The gathered evidence may include an event record. The gathered evidence may be hashed and/or encrypted prior to the storing in the storage. The control may be for compliance with at least one of a legal requirement, an accounting requirement, a security requirement, a risk management requirement or an organizational objective. The providing access to the gathered evidence may include generating a report of the gathered evidence on a user interface.

In accordance with an exemplary embodiment, a method is performed in a computing environment. Per the method, specifications of controls are received in a computer programming entity for managing evidence of compliance with the controls. The specifications of the controls specify evidence that is to be gathered to demonstrate compliance with the controls. The computer programming entity identifies the evidence that is to be gathered per the specifications of the controls. As activities proceed in the computing environment, the identified evidence is gathered. The gathered evidence is subjected to at least one of hashing, encryption or obfuscation to produce secured evidence. The secured evidence is in a storage in an immutable fashion by the computer programming entity. The secured evidence is referenced on a secure distributed ledger, and the secure distributed ledger is accessible to multiple parties, including at least one auditor for auditing compliance with controls.

The referencing of the evidence may be performed in real time or quasi real time relative to the proceeding of the activities, may be performed at time intervals or may be performed in a delayed fashion. The auditor may be a programmatic auditor. The method may include the additional steps of generating a report of at least some of the secured evidence by the computer programming entity for the auditor. The control may be for compliance with at least one of a legal requirement, an accounting requirement, a security requirement, a risk management requirement or an organizational objective. The computer programming entity may be one of a program, program suite, applet, script, library or other set of computer programming code.

In accordance with an exemplary embodiment, a non-transitory computer-readable storage medium stores instructions for execution by a processor. The instructions cause the processor to encrypt and/or hash evidence of compliance with a control. The control sets forth activities to be performed and/or conditions to be satisfied. The instructions also cause the processor to store the encrypted and/or hashed evidence in a storage, reference the evidence on a secure distributed ledger and access the secure distributed ledger to obtain the reference and programmatically examine the evidence regarding compliance with the control stored in the storage. The instructions further cause the processor to programmatically generate an output indicating compliance with the control where the examined evidence indicates compliance with the control, and where the examined evidence indicates lack of compliance with the control, to programmatically generate an output indicating non-compliance with the control.

The output may be a report demonstrating compliance with the control. The output may be an alarm of non-compliance with the control. The control may be for compliance with at least one of a legal requirement, an accounting requirement, a security requirement, a risk management requirement or an organizational objective. The evidence may be both hashed and encrypted.

### BRIEF DESCRIPTION OF THE DRAWINGS

FIG. 1 depicts a block diagram of illustrative controls, a control manager and a control compliance evidence manager in an exemplary embodiment.

FIG. 2A depicts an illustrative flow between the control manager and the control compliance evidence manager.

FIG. 2B depicts in more detail of a specification of a control.

FIG. 3A depicts a flowchart of illustrative steps that may be performed by the control compliance evidence manager.

FIG. 3B depicts a diagram illustrating the gathering, storing and encryption/hashing of evidence in an exemplary embodiment.

FIG. 4 depicts an illustrative portion of a blockchain on which control compliance evidence is referenced.

FIG. 5 depicts a flowchart of illustrative steps that may be performed in determining and acting on whether there is compliance with a control.

FIG. 6 depicts an illustrative user interface for obtaining information regarding controls and control compliance evidence.

FIG. 7 depicts a distributed computing environment suitable for practicing an exemplary embodiment.

FIG. 8 depicts an illustrative computing environment that includes a computing system for an exemplary embodiment.

### DETAILED DESCRIPTION

One of the difficulties with the use of controls in conventional systems is the difficulty of proving compliance with the controls. In general, the compliance is determined by a manual audit to gather evidence of compliance or non-compliance. Gathering such evidence manually is often a time-consuming and expensive process. The gathering of the evidence may be subject to human error and may be performed differently by different auditing parties. Still further, the auditing may be performed sporadically rather than on a periodic basis or on a non-periodic but ongoing basis. As a result, the gathered evidence may be error prone, incomplete and variable.

The exemplary embodiments eliminate the need for manual auditing and may overcome the problems of conventional auditing approaches. The exemplary embodiments may provide an automated control compliance evidence manager that is responsible for gathering evidence of compliance with controls. The automated control compliance evidence manager may operate on an ongoing basis. In some exemplary embodiments, the evidence is gathered and available for review in real time or near real time. The gathering of the compliance evidence is automated. The steps for gathering the compliance evidence may be specified at the time a control is established so that there is consistency in what is gathered and how the evidence is gathered. A user may be required to provide an itemization of what evidence is to be gathered and where. The evidence may be stored in an immutable fashion. In some exemplary embodiments, the evidence may be cryptographically hashed or otherwise encrypted and referenced by a secure distributed ledger, like a blockchain. The secure distributed ledger may be visible to concerned parties.

The control compliance evidence manager may have a reporting capability for generating reports or outputs regarding the evidence of compliance. For example, a report may be generated that produces evidence for a control for a certain time period. In some exemplary embodiments, a user interface may be displayed that enables a user to navigate among controls and see compliance evidence for the controls.

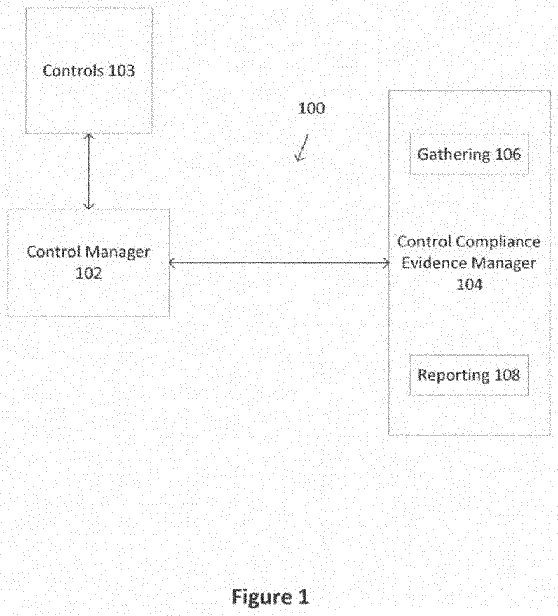

FIG. 1 depicts a block diagram 100 of several components that may be found in exemplary embodiments. A control manager 102 manages controls 103 for an entity, like an organization, a business, a governmental entity, a charitable organization, a religious organization, a school, etc. Generally, the control manager 102 may be used for any network or group of computers for which controls 103 are applied. A control 103 is a protocol or set of operations to be performed to prevent risks, mitigate risks and/or identify undesirable events. In a business entity, a control 103 may be a protocol or set of operations ensuring a business objective. Each of the controls 103 may be realized through computer program instructions and associated data in data structures. The control manager 102 may be realized in computer program instructions. The control manager 102 may be generalizable to manage controls of different types and manage all of the controls 103 for the entity. New controls 103 may be added and existing controls 103 may be removed and modified via the control manager 102.

In some instances, the controls 103 may include ones that are for ensuring compliance with standards or requirements, such as legal standards, accounting standards, compliance with the Hatch-Waxman Act, Defense Department regulations or standards, data security standards, etc. In other instances, the controls 103 are not for complying with standards or requirements. In some instances, a control 103 is for achieving an organizational objective.

The control manager 102 may interact with a control compliance evidence manager 104. The control compliance evidence manager 104 may be realized in software or more generally in computer program instructions. The control compliance evidence manager 104 is responsible for gathering evidence of compliance or non-compliance with a control and providing access to that evidence. The control compliance evidence manager 104 may include a gathering component 106 that gathers evidence from sources, like event logs, and stores the gathered evidence on a storage, such as a secure distributed ledger, like a blockchain. The control compliance evidence manager 104 may also include a reporting component 108 that may retrieve the gathered evidence from a storage like a secure distributed ledger and generate reports or other outputs of the evidence to a user.

The control manager 102, the controls 103 and the control compliance evidence manager 104 may interact in a number of different fashions. For example, the controls 103 may be defined as instances of control object classes in some exemplary embodiments. Methods may be defined for the object classes to interrogate the objects, so that the control compliance evidence manager 104 may interrogate the control objects or output data from the control objects. In other embodiments, Application Program Interfaces (APIs) may be defined to enable interaction between the controls 103, the control manager 102 and the control compliance evidence manager 104. There may be Remote Procedure Call (RPC) technology for facilitating interaction between the control manager 102, controls and the control compliance evidence manager 104. Those skilled in the art will appreciate that in other embodiments, the control manager 102 and the control compliance evidence manager 104 may be realized in web based environments, wherein the control compliance manager 104 may use web protocols to communicate with control manager 102 on a web server or in a cluster in a cloud based environment.

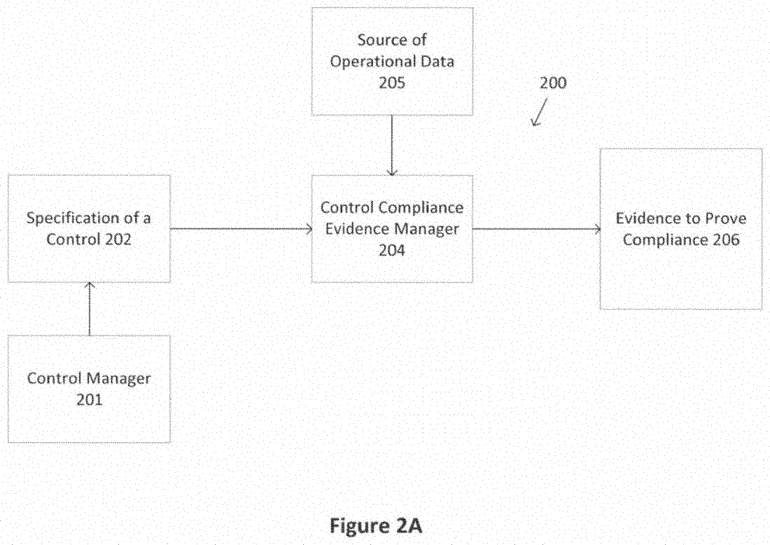

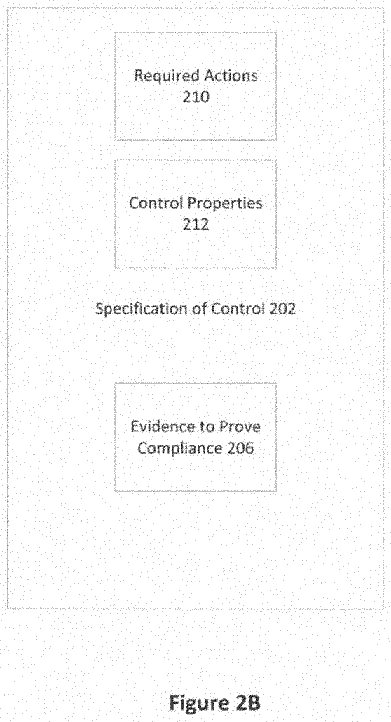

As can be seen in the diagram of FIG. 2A, the control manager 201 generates a specification of a control 202. This may entail creating a control object, a meta data object regarding a control or creating a data structure that holds properties and data for a control. The control manager 201 may create such a specification for each control that the control manager 201 manages. The control compliance evidence manager 204 obtains information from the specification of a control, such as described above. The control compliance manager also needs to know a source of operational data 205. Operational data may be produced by the organization's day to day operations. The operational data may come in different forms, such as in log files or in records of a database. Operational data may also come in the form of events from a near-real time data stream. This information 204 and 205 may be used to configure the gathering that is performed by the control compliance evidence manager 204. The evidence to prove compliance 206 is generated and stored and ultimately made available as needed by the control compliance evidence manager 204 as will be described in more detail below.

FIG. 2B depicts an illustrative example of a specification of a control 202. The specification of a control 202 specifies the required actions 210 for the control. The required actions 210 are those that must be performed as part of the control. There may be if-then-else logic among the required actions. For example, with the login example given above in the Background section, the required actions may include generating a prompt for login credentials, authenticating the login credentials, generating a two-part authentication prompt if a first part is properly entered and authenticating the input provided in response to the prompt. The specification of a control 202 may also hold property information 212 regarding the control. Further, the specification of a control 202 may identify the evidence to prove compliance 206. This evidence to prove compliance 206 may be an itemization of what evidence is needed to prove compliance and where that evidence is to be found, such as the source of operational data 205 (FIG. 2A).

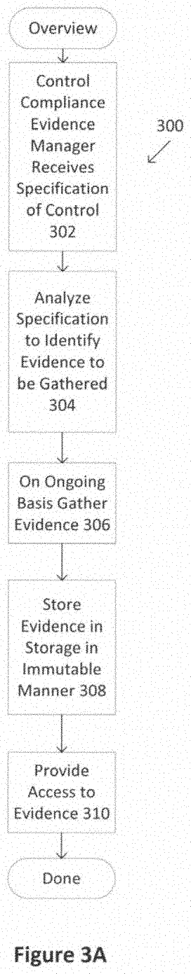

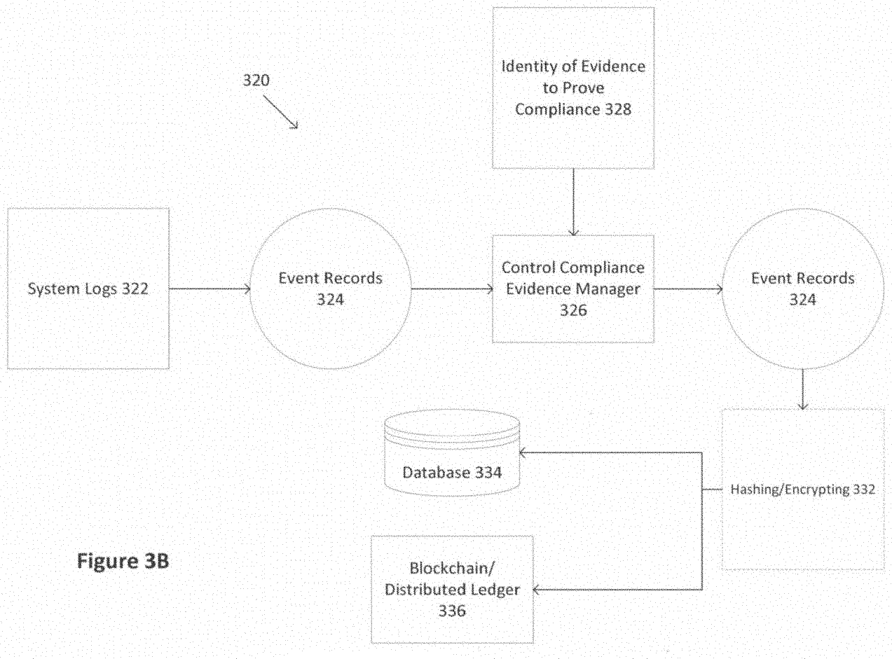

FIG. 3A provides a flowchart 300 that provides a high-level overview of the process for gathering and reporting evidence of compliance for a control by the control compliance evidence manager 204. Initially, the control compliance evidence manager 204 obtains access to the specification of a control 202 or the information specified therein (302). The control compliance evidence manager 204 then analyzes the specification 202 or the information contained therein to identify what evidence is to be gathered for the control (304). For example, with the login example, this may be event records proving that credentials prompt was generated, proving that the login credentials were authenticated, proving that the two-factor authentication prompt was generated and proving that input provided by the user in response to the prompt was authenticated. The control compliance evidence manager 204 may also determine what event logs or system logs hold such event records.

The control compliance evidence manager 204 may then begin the process of gathering the evidence on an ongoing basis from the source of operational data 205 (306). This may entail ingesting operational data from a data stream on an ongoing basis. This requires gathering the identified event records on an ongoing basis (306) and storing the gathered records in storage and referencing the gathered records on a secure distributed ledger, like a blockchain (308). As shown in diagram 320 of FIG. 3B, system logs 322 may hold event records 324 that are of interest based on the identity of the evidence to prove compliance 328 extracted from the specification of a control 202 (FIG. 2B). The event records 324 are examples of operational data discussed above. The reference and/or the gathered event records 324 may be subject to a cryptographic hash function or may more generally be encrypted 332. The evidence is stored in an immutable manner so that the evidence cannot be changed and hence is reliable (308). The evidence (i.e., the event records 324) may be stored in immutable storage, such as a blockchain/secure distributed ledger or a database 334 or the like. A secure distributed ledger also is accessible by multiple parties so that one part cannot forge, alter or modify data without others being aware of it. Moreover, multiple parties have access to the data. The data stored in the secure storage, like a secure distributed ledger, may then be accessed by the control evidence compliance manager to prove compliance or lack of compliance (310). As was mentioned above, reports of the evidence may be generated, or a user interface may facilitate access to the evidence that may be placed therein.

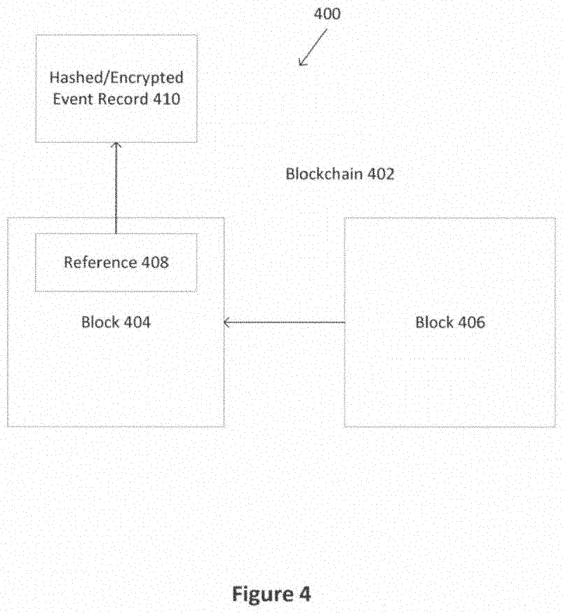

FIG. 4 depicts an illustrative portion of a blockchain 400 that may be suitable for storing evidence of compliance. The blockchain 400 includes successive blocks 404 and 406 that are linked (i.e., newer block 406 is linked to older block 404). Block 404 contains a reference 40, such as a link. The reference 408 references a hashed/encrypted event record 410 via a link. This event record constitutes evidence of compliance/noncompliance for a control. A blockchain 402 may contain all of the evidence for compliance with a control on an ongoing basis. The information stored therein may be accessible in real time or near real time. Similarly, the references to event records constituting evidence of compliance may be added to the blockchain 400 in real time or near real time as the event records are generated. The evidence may be gathered by a crawler program and stored on the blockchain 400 in some embodiments.

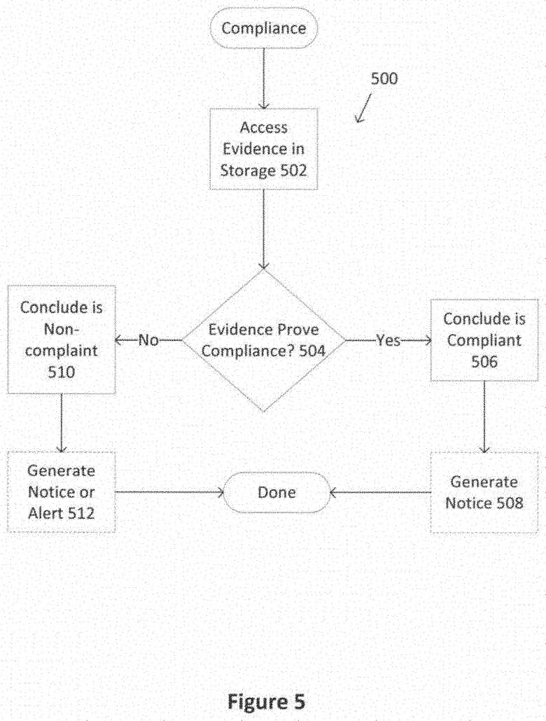

FIG. 5 depicts a flowchart 500 of illustrative steps that may be performed by the control evidence compliance manager 204 to prove compliance or non-compliance. The control evidence compliance manager 204 may access the evidence in the storage, such as the blockchain/secure distributed ledger 336 or the database (502). The evidence is examined to determine whether it proves compliance (504). For example, the evidence may be event logs, and the event records may be examined to determine whether the required actions for the control have taken place or not. If the required events have taken place, it is concluded by the logic in the control compliance evidence manager 204 that there has been compliance (506) and a compliance notice may be generated (508). On the other hand, if the evidence (e.g., event records) indicate that the required actions have not taken place, it is concluded that there has not been compliance (510). A notice or alert of the non-compliance may be generated (512). The notice or alert may identify what deficiency caused the non-compliance. For example, it may be determined that an action never took place and the notice identified the action as not being performed.

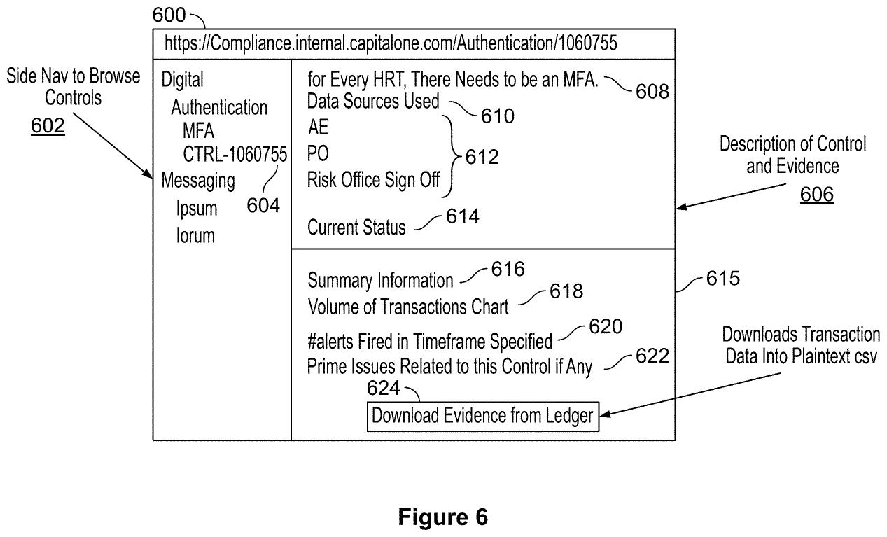

In some instances, a user interface may be provided that allows navigation of the controls and the associated evidence. Reports of the evidence may be generated from the user interface. Information regarding the evidence may be shown on the user interface. FIG. 6 shows an example of such a user interface 600. The user interface 600 includes a panel 602 that lists controls, such as control 604, for selection. Selection of a control causes information regarding the control to be displayed in panel 606. The information provides a description of the control 608, data sources for the evidence 610, evidence 612 for compliance with the control. The current status of the control 614 may be provided. Panel 615 may hold information such as summary information regarding compliance 616, a volume of transactions chart 618, the number of alerts fired in a timeframe 620 and the prime issues related to the control 622 if there are any issues. A button 624 may be activated to download evidence from the secure distributed ledger, blockchain or database.

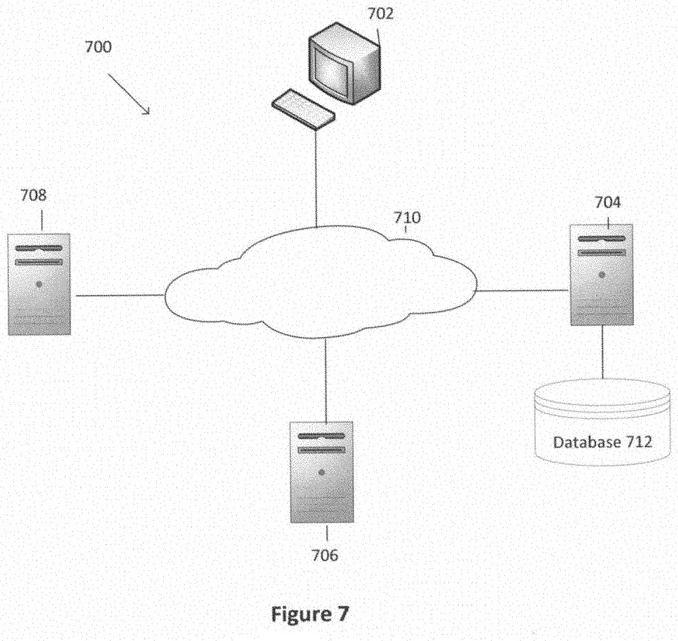

FIG. 7 depicts a distributed computing environment 700 suitable for practicing the exemplary embodiments. The distributed computing environment may include a number of servers 704, 706 and 708 that are connected to a network 710. The network 710 may include a local area network and/or a wide area network, like the Internet. The servers 704, 706 and 708 may be part of a cloud computing environment or may be resident on a network, such as a web-based network. A client computing system 702 may also connected to the network 710. The control manger 102 and the control compliance evidence manager may be present on one or more of the servers 704, 706 and 708 or on the client computing device 702. If servers 704, 706 and 708 belong to different organizations, each server will have access to a different copy of the blockchain or secure distributed ledger, and each blockchain or secure distributed ledger copy is guaranteed to be immutable and in sync with the other copies because of the blockchain's distributed consensus mechanism. The blockchain or secure distributed ledger utilizes the capabilities of the network 710 to help implement this consensus. In other embodiments, the servers 704, 706 and 708 may be part of a single organization and have a single copy of the blockchain or secure distributed ledger. The blockchain or secure distributed ledger may be accessible by the servers 704, 706, and 708. The servers 704, 706 and 708 may be part of a cloud computing service or may be web servers that may be accessed by the client computing device 702. In one exemplary embodiment, the control compliance evidence manager is present on server 704 and has access to a database 712.

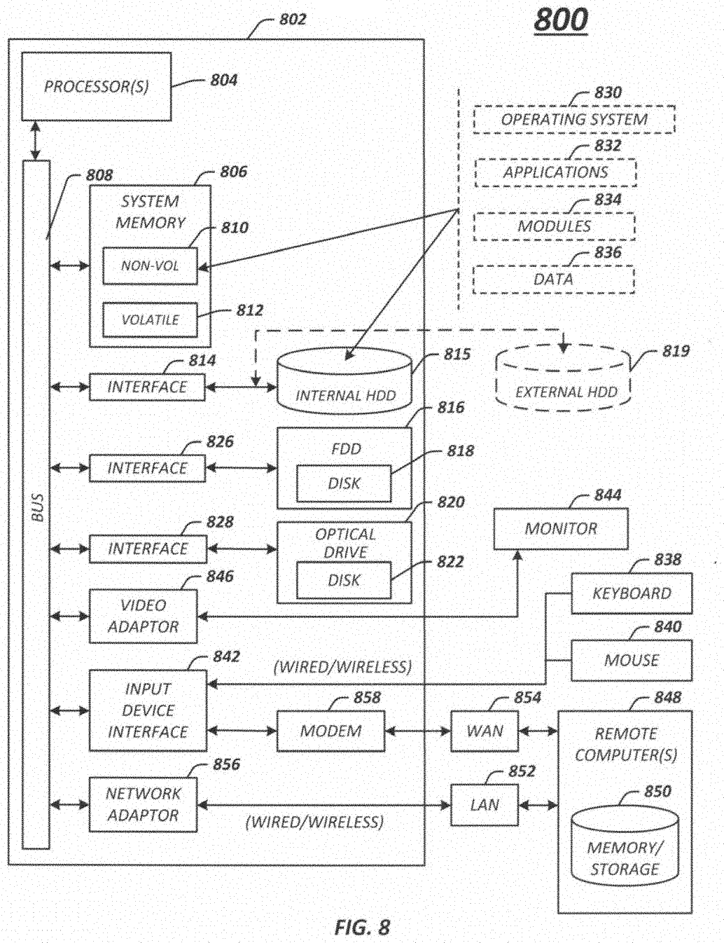

The methods described herein may be performed by a computing environment 800, such as that depicted in FIG. 8. FIG. 8 illustrates an embodiment of an exemplary computing environment 800 that includes at least one computing device 802 (such as client computing device 702 or servers 704, 706 or 708) that may be suitable for implementing various embodiments as previously described. In various embodiments, the computing environment 800 may comprise or be implemented as part of an electronic device. The computing device 802 may be part of a cluster or may be part of a cloud computing environment. The methods described herein may, in some embodiments, be performed across computing resources on multiple computing devices, like 802.

As used in this application, the terms “system” and “component” and “module” are intended to refer to a computer-related entity, either hardware, a combination of hardware and software, software, or software in execution, examples of which are provided by the exemplary computing environment 800. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing device 802 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing device 802.

As shown in FIG. 8, the computing device 802 may include one or more processors (including one or more cores each) 804, a system memory 806 and a system bus 808. The processor 804 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multiprocessor architectures may also be employed as the processor 804.

The system bus 808 provides an interface for system components including, but not limited to, the system memory 806 to the processor 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computing device 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies. The computing device 1302 is generally is configured to implement logic, systems, methods, apparatuses, and functionality described herein with reference to FIGS. 1-7.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system

A user can enter commands and information into the computing device 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processor 804 through an input device interface 842 that is coupled to the system bus 808 but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computing device 802. In addition to the monitor 844, a computer typically includes other peripheral output devices, such as speakers, printers, and so forth.

The computing system 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computing system 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computing device 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computing device 802 can include a modem 858, or is connected to a communications server on the WAN 854, or has other means for establishing communications over the WAN 854, such as by way of the Internet. The modem 1358, which can be internal or external and a wire and/or wireless device, connects to the system bus 808 via the input device interface 842. In a networked environment, program modules depicted relative to the computing device 802, or portions thereof, can be stored in the remote memory/storage device 850. It will be appreciated that the network connections shown are exemplary and other means of establishing a communications link between the computers can be used.

The computing device 802 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

1. A method performed in a computing environment, comprising:
receiving a specification of a control in the computing environment and a source of operational data, wherein the specification of the control sets forth activities to be performed and/or conditions to be satisfied as part of the control and also specifies evidence of compliance with the control to be generated;
programmatically analyzing the specification of the control to identify the evidence of compliance to be generated and programmatically causing the evidence to be generated from the source of operational data;
storing the generated evidence in a storage in an immutable manner, wherein the evidence is referenced on a secure distributed ledger;
programmatically gathering the generated evidence from the secure distributed ledger;
analyzing the gathered evidence to determine whether there has been compliance with the control;
where it is determined that there has been compliance, generating a notice of compliance or a report that is output on an output device;
where it is determined that there has not been compliance, generating one of a notice or an alert of non-compliance.

2. The method of claim 1, wherein the generating of the evidence and the storing of the evidence occurs in real time, in near-real time, at time intervals or in a delayed fashion.

3. The method of claim 1, wherein the analyzing is performed by a programmatic entity.

4. The method of claim 1, wherein the programmatically gathering the evidence comprises processing system logs to extract the evidence or processing a stream of events.

5. The method of claim 1, wherein the gathered evidence is stored in one of a database or a secure storage

6. The method of claim 1, wherein the gathered evidence includes an event record.

7. The method of claim 1, wherein the gathered evidence is hashed and/or encrypted prior to the storing in the storage.

8. The method of claim 1, wherein the control is for compliance with at least one of a legal requirement, an accounting requirement, a security requirement, a risk management requirement or an organizational objective.

9. The method of claim 1, wherein the providing access to the gathered evidence comprises generating a report of the gathered evidence on a user interface.

10. A method performed in a computing environment, comprising:
receiving specifications of controls in a computer programming entity for managing evidence of compliance with the controls, wherein the specifications of the controls specify evidence that is to be gathered to demonstrate compliance with the controls;
with the computer programming entity, identifying what evidence is to be gathered per the specifications of the controls;
as activities proceed in the computing environment, gathering the identified evidence;
subjecting the gathered evidence to at least one of hashing, encryption or obfuscation to produce secured evidence;
storing the secured evidence in a storage in an immutable fashion;
referencing the secured evidence on a secure distributed ledger, wherein the secure distributed ledger is accessible to multiple parties, including at least one auditor for auditing compliance with controls.

11. The method of claim 10, wherein the referencing the evidence is performed in real time or quasi real time relative to the proceeding of the activities, is performed at time intervals or is performed in a delayed fashion.

12. The method of claim 10, wherein the auditor is a programmatic auditor.

13. The method of claim 10, further comprising generating a report of at least some of the secured evidence by the computer programming entity for the auditor.

14. The method of claim 10, wherein the control is for compliance with at least one of a legal requirement, an accounting requirement, a security requirement, a risk management requirement or an organizational objective.

15. The method of claim 10, wherein the computer programming entity is one of a program, a program suite, an applet, a script, a library or another set of computer programming code.

16. A non-transitory computer-readable storage medium storing instructions for execution by a processor, wherein the instructions cause the processor to:
encrypt and/or hash evidence of compliance with a control, wherein the control sets forth activities to be performed and/or conditions to be satisfied;
store the encrypted and/or hashed evidence in a storage;
reference the evidence on a secure distributed ledge;
access the secure distributed ledger to obtain the reference and programmatically examine the evidence regarding compliance with the control stored in the storage;
where the examined evidence indicates compliance with the control, programmatically generate an output indicating compliance with the control; and
where the examined evidence indicates lack of compliance with the control, programmatically generate an output indicating non-compliance with the control.

17. The non-transitory computer-readable storage media of claim 16, wherein the output is a report demonstrating compliance with the control.

18. The non-transitory computer-readable storage medium of claim 16, wherein the output is an alarm of non-compliance with the control.

19. The non-transitory computer-readable storage medium of claim 16, wherein the control is for compliance with at least one of a legal-requirement, an accounting requirement, a security requirement, a risk management requirement or an organizational objective.

20. The non-transitory computer-readable storage medium of claim 16, wherein the evidence is both hashed and encrypted.
